(19) United States
(12) Patent Application Publication
(10) Pub. No.: US 2024/0230430 A1
(43) Pub. Date: Jul. 11, 2024

(54) MONITORED SPRING ASSEMBLY, AND METHODS FOR MANUFACTURING AND OPERATING SAME

(71) Applicant: Federnfabrik Schmid AG, Oetwil Am See (CH)

(72) Inventor: Albert Enste, Zürich (CH)

(21) Appl. No.: 18/556,481

(22) PCT Filed: Apr. 11, 2022
(86) PCT No.: PCT/EP2022/059634

§ 371 Date: Apr. 2, 2024

(30) Foreign Application Priority Data
Apr. 22, 2021 (DE) 10 2021 110 346.0

(51) Int. Cl. G01L 1/04; G01L 1/26

(52) U.S. Cl. CPC G01L 1/04; G01L 1/26

(57) ABSTRACT

The invention relates to a resilient assembly (1) which, in addition to the resilient component (2), usually a simple spring (2), comprises a measuring assembly (20) having a load sensor (3) for measuring the load on the spring (2) during operation and transmitting it to a monitoring unit (50) by means of a wireless transmitting unit (4).

### I. FIELD OF APPLICATION

The invention relates to resilient components, which generally have only a limited service life because they become non-functional due to fatigue or overload, changing their spring behavior or being completely destroyed.

### II. TECHNICAL BACKGROUND

The occurrence of the functional incapacity of an installed spring usually leads to an immediate failure or shutdown of the entire superordinate machine unit and, in the worst case, can lead to an accident.

The downtime of the machine unit due to necessary replacement of the defective spring, the associated repair costs and, if necessary, the prior procurement of spare parts, usually represents a high loss compared to the value of the spring.

In addition, the defects of each individual spring, which occur at different times, again cause such a downtime.

Although the expected normal service life of the spring under the target operating conditions is generally known, these operating conditions may change in practice, in particular an unexpected overload may occur or may have occurred and, in particular, may not have been noticed, thus shortening the target service life.

### III. REPRESENTATION OF THE INVENTION

### A) TECHNICAL OBJECT

It is therefore the object in accordance with the invention to provide a resilient assembly which is as cost-effective as possible, the actual load of which is checked during operation, preferably is checked continuously, and from this the time of the probable actual failure of the resilient component can be predicted much more accurately, the remaining force of the spring can be calculated, and the probability of failure in the current state can be calculated. It is further the object of the invention to provide a method for the cost-effective production as well as operation of such a resilient assembly.

### B) SOLUTION OF THE OBJECT

This object is achieved by the features of claims 1 and 11. Advantageous embodiments result from the subclaims.

A generic spring assembly comprises, on the one hand, the resilient component—referred to below as the spring for short—and a measuring assembly operatively connected thereto and having a load sensor, in particular a load sensor fastened thereto, a storage unit for temporarily storing the measured data, and a transmitting unit for wirelessly transmitting the load measured values measured by the load sensor to a superordinate monitoring unit.

Since the load sensor and/or the transmitting unit require energy for their function, such a spring assembly also has an energy supply. Since as a rule both the load sensor and the transmitting unit, as well as other components mentioned below which require energy for their function, are operated by means of electric current, the energy supply is a power supply.

In the following, only electric current will be referred to as the form of energy used, without limiting the invention thereto.

According to the invention, this energy supply comprises an energy generator, in particular a power generator, in particular as part of the spring assembly.

In addition or instead, there may be an energy storage, in particular a battery, which ensures the energy supply and which can be recharged without contact, for example by means of induction or by means of electromagnetic radiation, which can be converted into electric current by one of the components of the spring assembly.

In this manner, the load on the spring can be measured continuously or at intervals over a long period of time, so that conclusions can be drawn about the residual force, the probability of failure and the remaining service life of the spring from the magnitude of the load on the spring, the frequency of the load and/or the duration of the load.

This is done particularly automatically by an evaluation unit, which may be designed together with the superordinate monitoring unit or may be a part of the monitoring unit, such that—preferably via an output unit—the operator can be informed about the remaining force of the spring and when or whether the remaining life of the monitored spring ends or whether a breakage of the spring has occurred.

Preferably, the load is determined by measuring the torsion or bending or strain of the spring by means of the load sensor, for example by means of a strain gauge (DMS) or an opto-electric sensor as load sensor.

Such strain gauges and, to a certain extent, opto-electrical sensors are very cost-effective and have a very long service life if housed in a suitably mechanically protected manner, and need only be applied, in particular glued, to the surface of the spring at a suitable location, preferably at a location where the torsion or bending or strain of the spring is greatest during operation.

To ensure that no load values are lost if data transmission does not take place at the same time, the spring assembly preferably has a data storage in which the load measured values are temporarily stored or generally stored until they are transmitted to the monitoring unit. This is preferably a so-called non-volatile data storage, which is understood to mean a data storage that does not lose its information content even in a currentless state, although of course in normal operation the data storage is also supplied with energy, preferably electrical current, from the energy supply.

Since the spring assembly is often mounted in locations that are difficult to access, it is important that the spring assembly can operate self-sufficiently for as long as possible for both the power supply and the interrogation of measured values.

Preferably, the energy supply of the spring assembly comprises a buffer storage for energy, preferably a battery, which can be easily recharged:

The recharging can be effected by an internal energy generator, which is part of the spring assembly, or by an external energy supplier, which supplies energy to the spring assembly without contact, preferably also over a greater distance, for example by means of electromagnetic waves.

The energy supplier can also be the data interrogation unit of the superordinate monitoring unit at the same time. For example, the data interrogation unit may be an RFID antenna and the transmitting unit of the spring assembly may be an RFID tag that transmits the information contained in the RFID tag to the interrogation unit upon request by means of the RFID antenna, but at the same time receives energy via the interrogation signal from the RFID antenna that can be used to recharge such a buffer battery.

The transmitting unit can also be a Bluetooth low energy unit or a specifically designed communication unit.

Also, the energy supplier can generate electrical energy by means of other methods, such as piezoelectric effect or Peltier effect.

An internal energy generator, in particular an internal power generator, may be a separate part from the other electrically operated components, or may be functionally combined with one of these electrically operated components of the spring assembly.

For example, one of the sensors of the spring assembly, or even the transmitting unit, could be designed to generate power through their operation, wherein in particular the strain or movement of either the energy generator or the spring to which the energy generator is mostly fastened is converted into energy, or also the temperature of the energy generator or the part to which it is fastened can be used to generate energy.

Such an energy generator can be, for example, a piezo element or a Peltier element, which is known to generate current from a temperature, in particular a temperature difference, wherein such a temperature difference can be generated, for example, by an insulating enclosure of the spring assembly, which causes different temperatures to prevail on the inside and outside of the enclosure. Also, the Peltier element may be mounted on the printed circuit board or other carrier element of the spring assembly, and generate current from the temperature differences present there.

Preferably, the transmitting unit can also be designed to receive data, i.e., be designed as a combined transmitting/receiving unit, whereby not only energy-supplying electromagnetic waves can be picked up by the transmitting/receiving unit and converted into current, but also control signals can be sent to the spring assembly, for example control signals for activating the load sensor at a certain point in time or similar.

A so-called passive transponder also does not require its own energy supply and delivers data stored in it on interrogation, wherein the energy for sending the data is only transmitted by means of the interrogation signal.

The spring assembly can be further configured by having additional components, in particular additional sensors, and/or at least one LED. By means of the LED, certain states can be communicated to the operator, for example, overload on the spring or just the readiness to communicate with the spring assembly.

On the one hand, this could be a temperature sensor that can be used to measure the temperature of the spring or of the air around the spring, which is of interest because the temperature has a considerable influence on the service life of a spring—which is generally understood to mean a spring made of metal.

For the same reason, a pollutant sensor can be present that measures the content of substances harmful to the spring on the spring or in the ambient air.

For the same reason, an acceleration sensor or position sensor may be present that measures the acceleration of the spring assembly or the distance it travels. These values can be used as a trigger signal for measuring the spring load.

Further, an analog-to-digital converter may be present to convert the data, which is usually supplied in analog form, into a digital signal that can be more easily stored and also sent.

By means of a measuring amplifier it is further possible to amplify the usually relatively weak, mostly analog, measuring signals.

The design of the spring assembly is particularly simple if different functions can be combined in one component, i.e., functionally unified:

As an example, an RFID tag contains current-conducting conductive tracks, usually in spiral form, applied to a rigid or flexible plastic circuit board.

Also used as an example here is a Peltier element, which may be contained in the spring assembly and can generate current due to the temperature differences on its two sides.

Portions of these conductive tracks or even the entire conductive track could be used on the one hand as a load sensor and/or on the other hand for energy generation, the latter for example by sending signals from the interrogation unit to the RFID tag, which do not have the purpose of interrogating measured values at all, but only serve to send electromagnetic beams containing energy to the RFID tag and thus ultimately to charge or recharge the buffer battery.

A DMS used as a load sensor could also be used to generate current.

With regard to the method for operating a spring assembly, which is designed in particular as described above, this object is achieved in that during operation the load on the spring is measured continuously or also only at intervals, in particular either only on request or triggered by a defined acceleration threshold value or minimum distance covered, which is measured by means of a corresponding sensor, and the load measured values are transmitted wirelessly to a monitoring unit.

An evaluation unit there informs the operator as far in advance as possible of the approaching end of the service life of the monitored spring or at least reports the breakage of such a spring very quickly. Alternatively, an evaluation unit can be integrated in the spring assembly and report critical loads to the superordinate unit. This evaluation unit can also cause an LED on the spring assembly to then light up as a warning.

In this manner, downtimes of systems can be minimized by replacing one or more installed springs as a preventive measure shortly before they reach the end of their service life; in the case of several installed springs, if possible not only one, but a whole group or all springs.

Since the factors influencing the service life, such as temperature, pollutants in the environment, magnitude and frequency of the load and its duration, can also be taken into account by an evaluation unit, the springs are not replaced too early and there is no unnecessarily frequent downtime of the corresponding system.

The load on the spring is preferably determined based on the bending of the spring because, in conjunction with the material characteristics of the spring, this is one of the parameters from which conclusions can best be drawn about the residual spring force and the residual service life of the spring.

The energy-requiring components of the spring assembly, such as the load sensor or transmitting unit, are preferably operated with electric current, such that an existing buffer store for energy is usually a battery that can be recharged.

Because of the rechargeability, the buffer battery can be chosen to be small and cost-effective, and thus the entire spring assembly can be small and cost-effective, which is particularly advantageous for attachment to the spring.

Such a buffer storage is recharged either from outside the spring assembly without contact, either via induction or by means of electromagnetic radiation, but without such an energy supplier having to be brought too close to the spring assembly. In particular, this can be done without relocation from a superordinate monitoring unit, usually permanently mounted in the vicinity of the spring assembly, which may include such an energy supplier and/or an interrogation unit, which may be functionally unified.

The buffer storage may instead or additionally be recharged by means of an internal current generator that is part of the spring assembly, whether via an RFID tag or passive transponder or other current generator capable of generating current from a movement, temperature, temperature difference, or strain of a component.

The measurement of the load on the spring can be carried out at predefined times or only on request from the outside, which of course greatly reduces the energy required for the load sensor and the storage unit for the measured values.

### C) EXEMPLARY EMBODIMENTS

Embodiments according to the invention are described in more detail below by way of example. In the figures:

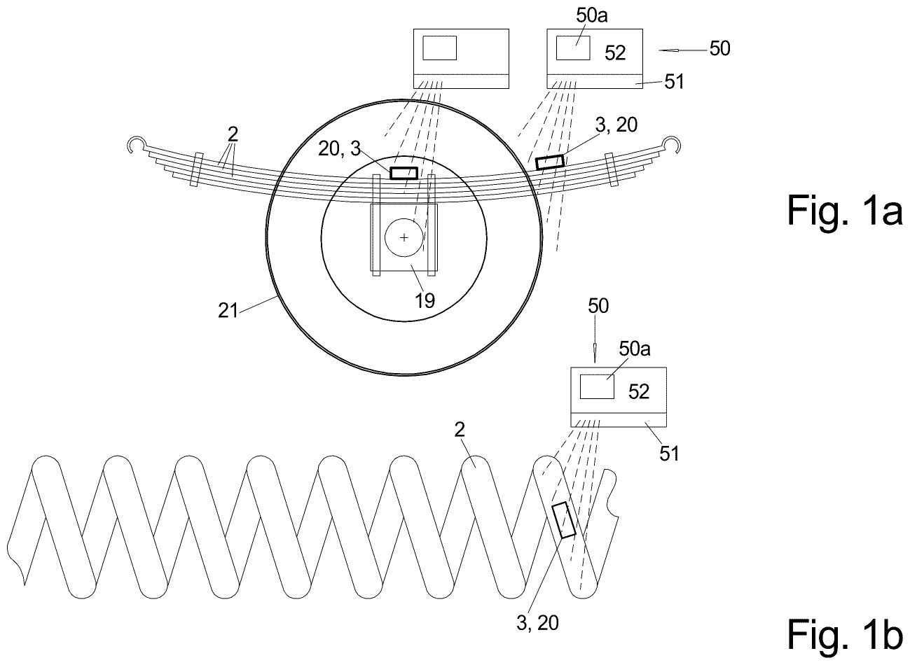

FIG. 1a: shows a leaf spring package on a motor vehicle axle having a measuring unit,

FIG. 1b: shows a spiral spring having measuring unit,

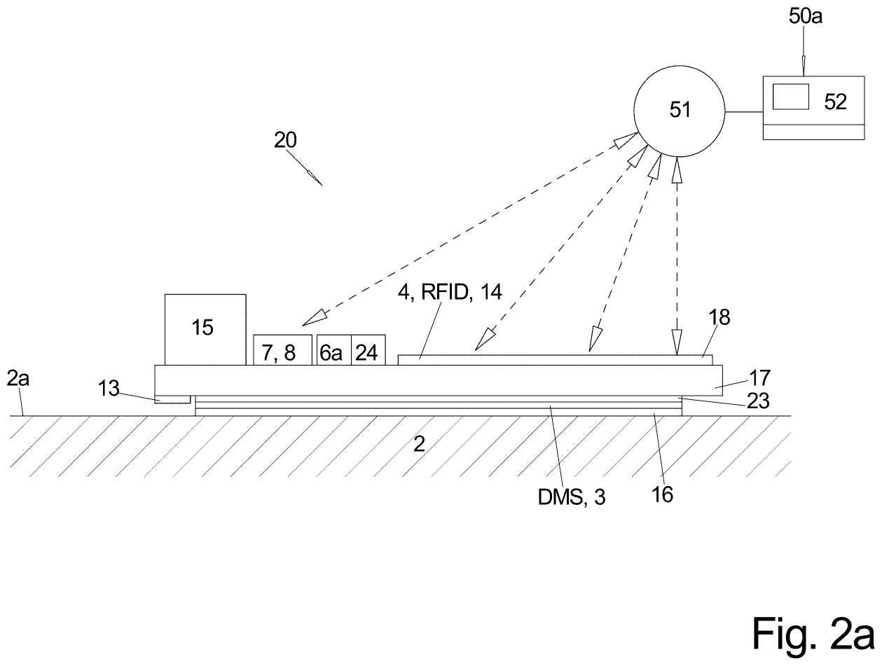

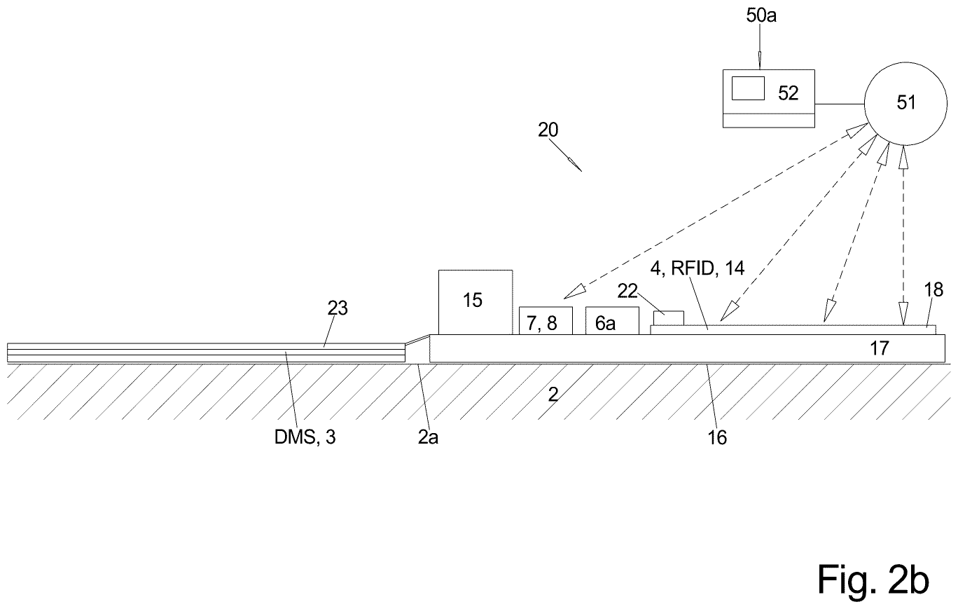

FIG. 2a, b: shows the measuring assembly applied to the surface of a spring in side view,

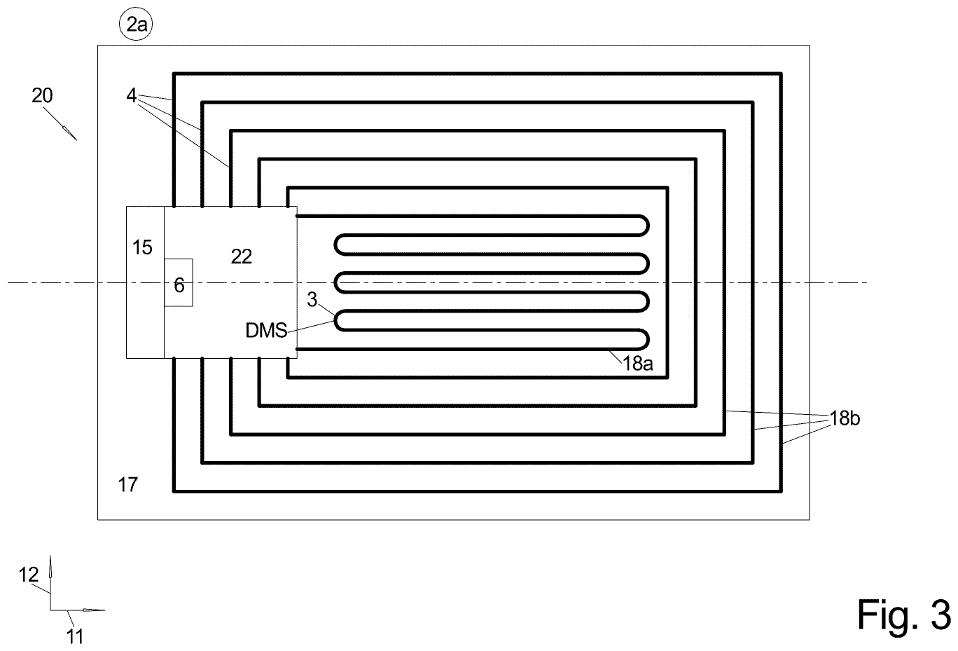

FIG. 3: shows a measuring assembly glued to a spring in top view.

FIG. 1a shows as a resilient component 2 a leaf spring assembly on a motor vehicle axle, which generally as represented consists of a plurality of individual leaf springs 2 placed one on top of the other and curved convexly downwards, which are held together by clamps. In this case, the axle body 19 is fastened extending in the transverse direction to the direction of extension under the leaf spring assembly by having such a spring assembly in each of the two end areas of the axle body 19 and by having a wheel 21 rotatably fastened to each end of the axle body 19.

Two locations are represented where the load sensor 3 or the entire measurement assembly 20 may be fastened to one of the springs 2 of the spring package:

Once approximately in the middle between the end fastening points of the spring package, i.e., at the same location where the axle body 19 is located underneath, therefore preferably on the upper side of the spring package. As a rule, these should be the locations where the highest tensile load on the material occurs, since material fatigue or material degradation at this location of highest load is also the cause of damage to the spring, up to and including fracture.

In the event of deflection in the vertical direction, the strain occurring in this area, for example, of the uppermost spring 2 in this case is determined by the load sensor 3 or the sensory system 20.

However, the path of movement of the spring 2, and thus the measurement assembly 20, may be relevant due to its movement if the measurement assembly 20 comprises an energy generator 14.

FIG. 1b shows a spiral spring in which the load sensor 3 is applied, in particular glued, to a coil, in particular its inner side, of the spiral spring 2, or also an entire measuring assembly 20 including the load sensor 3.

In all these cases, the measuring assembly 20 is in wireless communication, either continuously or also only sporadically, with a monitoring unit 50 which, on the one hand, comprises an interrogation unit 51 for interrogating the measured values from the measuring assembly 20, with which it can enter into wireless connection, and which, on the other hand, generally has an evaluation unit 52 for evaluating the received measured values. Such a monitoring unit 50 does not necessarily have to be installed on the spring, but can be a mobile device, including a cell phone or tablet or the like, which is brought into the vicinity of the spring assembly only to read out the data. This will be particularly the case if the spring assembly is designed to be able to work, measure and store measurement data self-sufficiently for a longer period of time.

In order to communicate the results of the evaluation unit 52 to the operator, the monitoring unit 50 also has an output unit 50a, in this case represented as a display on the monitoring unit 50.

FIG. 2a shows in a 1st design such a measuring assembly glued on a spring 2:

The load sensor 3, for example a DMS or an opto-electrical sensor, is glued to the outer surface of a spring 2 by means of an adhesive layer 16.

The load sensor 3, such as a DMS or an opto-electrical sensor, can in turn be located on the underside of a conventional electronic circuit board 17 and be connected to it firmly but preferably only at points, if possible at only one connection point, which can carry further electrical or electronic components on its upper side facing away from it.

In the case of a large-area connection, the limited ductility and flexibility of the circuit board 17 would have a detrimental effect on the measurement result.

Here, for example, a transmitting unit 4 is present, for example, in the form of the electrical conductive tracks 18 which are applied to the circuit board 17 and which may represent a transmitting unit 4 such as an RFID transponder or also called an RFID tag, at least together with an electronic circuit not shown which is connected to the conductive tracks 18 of the RFID tag.

The transmitting unit can also be a Bluetooth low energy unit or a specifically designed communication unit.

On the circuit board 17, in particular also on the upper side facing away from the load sensor 3, there may further be present an electronic data storage 6, preferably a non-volatile data storage 6, as well as an analog-to-digital converter 7 and/or a measuring amplifier 8 and an electronic circuit 22, which can also operate as an evaluation unit.

A buffer storage 15 for energy, in particular a buffer battery 15, may also be provided on the circuit board 17.

All electrical or electronic components are electrically conductively connected to each other in accordance with their function.

Also arranged on the circuit board 17—but not absolutely necessary in this case—on the underside and away from the load sensor 3 is a pollutant sensor 13, which is intended to determine certain pollutants in the immediate environment of the spring 2 and, depending on the design, may also be in contact with the spring 2.

Furthermore, an acceleration sensor 24 may also be present.

The pollutant sensor 13 and the acceleration sensor 24 can of course also be electrically interconnected with the other electronic designs.

A buffer battery 15 might be dispensable if measured only when interrogated by the monitoring unit 50 and its interrogation unit 51 by means of the load sensor 3 and using the electrical energy supplied by the interrogation unit 51 by the electromagnetic radiation of the interrogation.

Preferably, however, the measurements by the load sensor 3 are to be possible independently of the time at which the monitoring unit 50 interrogates measured values, and for this purpose a buffer battery 15 is provided which is recharged, for example, by an energy generator 14 which is preferably also present on the circuit board 17.

Preferably, the DMS or the opto-electric sensor and the electronics circuit board 17 may also not be connected to one another over their surface, but may be arranged next to one another in accordance with the side view of FIG. 2b, such that the slight extensibility of the carrier film 23 of the DMS, which is made of plastic such as acrylic, phenol or polyamide, is not negatively influenced by the surface-to-surface connection to the rigid and much less extensible electronics circuit board 17.

FIG. 3 shows a top view of a measurement assembly 20 comprising both a load sensor 3 and a transmitting unit 4 in the form of an RFID tag.

The latter consists of an electronic circuit 2 which is applied, in particular soldered, to the electronics circuit board 17 and with the plurality of concentrically arranged annularly almost closed c 18b, which can also be designed on the electronics circuit board 17 in a known manner and are connected at the respective free ends to an electronic circuit 22.

The transmitting unit 4 formed by the conductive tracks 18 and the electronic circuit 22 is also designed as a receiving unit and can receive signals via these concentric conductive tracks 18b, which also act as an antenna.

On the one hand, the concentric conductive tracks 18 are adapted to receive the interrogation signal and generate energy which is then temporarily stored in the buffer battery 15 coupled to the electronic circuit 22.

The electronic circuit 22 may also comprise such circuit parts which is suitable for connecting the resistor wire of a DMS and registering its changing voltage values and storing them, in particular, in a data storage 6 which is preferably part of the electronic circuit 22.

Instead of the DMS, an opto-electric sensor can also be used as the stress sensor, which optically detects and registers strains and can store the strain changes in a data storage 6, which is preferably part of the electronic circuit 22.

The resistor wire may also be in the form of conductive tracks 18 applied to the circuit board 17, for example by vapor deposition.

In the case shown, the conductive track 18a of the DMS is designed in the form of long meandering loops extending in a primary direction, namely in the central inner free space of the concentrically extending conductive tracks 18b of the RFID.

The main direction of extension of these meandering loops represents the preferred measuring direction of the DMS, such that the entire circuit board 17 is typically longer in this main direction of extension, the first surface direction 11 of the circuit board 17, than in the second surface direction 12, which extends transversely, preferably perpendicularly thereto.

This allows the user to see which is the measuring direction of the measuring assembly 20, which, in addition to the components shown in FIG. 3 on the upper side of the circuit board 17, may comprise on the lower side, for example, only an adhesive layer 16 for fastening to the spring 2.

Ideally, conductive tracks 18 applied to the circuit board 17 should be usable both as a load sensor 3 and/or as an RFID antenna and/or as an energy generator 14, for example at different times.

Thus, the meander-shaped conductive tracks 18a, which are primarily designed as DMS resistance wires, can serve as antennas for the transmitting/receiving unit 4 at times outside of a load measurement like the concentric conductive tracks 18.

Further, both the conductive tracks 18b of the RFID and the conductive tracks 18a of the DMS can be used as an energy-generating piezo element if their conductive tracks 18a, b are made of a semiconductor such as silicon, which has a piezoelectric effect in the form of current generation under mechanical stress.

The current thus generated by means of the movement and/or straining/compression of the spring 2 and analogous movement and straining or compression of such a piezo element can then be tapped at least apart from the times when these conductive tracks 8a, b are to perform another function, such as RFID antenna or DMS, and thus charge the buffer battery 15.

In this sense, the representation of FIG. 3 may show not only a top view of the upper side of a hard electronics circuit board 17, but also a top view of a thin and elastic carrier film 23, such as is required for a DMS as a carrier for its conductive tracks 18h.

In this case, in particular, the electronic circuit 22 and/or the data storage 6 and/or the buffer battery 15 may be accommodated apart from such a carrier film, for example on an electronic circuit board 17 located next to it, in contrast to the representation of FIG. 3.

### LIST OF REFERENCE SIGNS

1 spring assembly
2 resilient component, spring
2a surface
3a load sensor, strain sensor, DMS
3b opto-electric sensor
4 transmitting unit, RFID
5 energy supply
6 data storage
7 analog-to-digital converter
8 measuring amplifier
9 temperature sensor
10 perpendicular to the surface
11 1st surface direction
12 2nd surface direction
13 pollutant sensor
14 energy generator
15 buffer storage
16 adhesive layer
17 circuit board
18 conductive track
19 axle body
20 measuring assembly
21 wheel
22 electronic circuit
23 carrier film
24 movement sensor
50 monitoring unit
50a output unit
51 interrogation unit
52 evaluation unit
DMS strain gauges

1. A spring assembly comprising:
a resilient component;
a measuring assembly operatively connected to the resilient component, which comprises:
a load sensor;
a data storage, for storing load measured values;
a transmitting unit for wirelessly transmitting the load measured values;
an energy supply for supplying at least the load sensor with energy,
wherein the energy supply comprising an energy generator and/or an energy storage.

2. The spring assembly according to claim 1,
wherein the load sensor is a strain sensor.

3. The spring assembly according to claim 1,
wherein the load sensor is fastened to a surface of the resilient component.

4. The spring assembly according to claim 1,
wherein the data storage is also supplied with energy by the energy supply.

5. The spring assembly according to claim 1,
wherein the spring assembly comprises:
an analog-to-digital converter for digitizing the analog measured values;
and/or
an electronic circuit for evaluating the analog measured values;
and/or
a measuring amplifier for amplifying the analog measured values,
and/or
a temperature sensor for measuring an environmental temperature around the spring assembly;
and/or
a pollutant sensor for measuring a content of pollutants harmful to the resilient component in ambient air or on the pollutant sensor;
and/or
an acceleration sensor for measuring the acceleration of the resilient component;
and/or
a position sensor for measuring a distance traveled by the resilient component;
wherein one or more of the aforementioned electrical components are supplied with energy by the energy supply.

6. The spring assembly according to claim 1,
wherein:
the energy supply has a buffer storage for energy, which is recharged in a contactless manner by the energy generator or an external energy supplier;
the external energy supplier is an RFID antenna;
and/or
the form of energy with which at least the load sensor is operated and/or which is generated and optionally buffered is electric current, and the buffer storage for energy is a battery.

7. The spring assembly according to claim 1,
wherein either:
the spring assembly comprises an energy generator separate from the other said electrical components; or
the load sensor or a temperature sensor or the transmitting unit is designed such that this component generates energy through its operation
by the energy generator converting a strain or movement or temperature of the resilient component into energy; and
the energy generator is a piezo element or a Peltier element.

8. The spring assembly according to claim 1,
wherein the transmitting unit is also designed to receive data.

9. The spring assembly according to claim 1,
wherein the transmitting unit is an RFID tag or a passive transponder.

10. The spring assembly according to claim 1,
wherein at least part of conductive tracks or current conductors of an RFID tag is simultaneously a load sensor and/or an energy generator.

11. A method for operating a spring assembly comprising:
a resilient component;
a load sensor which is operatively connected to the resilient component;
a transmitting unit; and
an energy supply having an energy generator and/or a contactless rechargeable energy storage,
wherein:
the load on the resilient component is measured continuously or at intervals during operation, in particular only on request from outside;
the load measured values are stored in a data storage; and
the load measured values are transmitted wirelessly to a monitoring unit.

12. The method according to claim 11,
wherein the load on the resilient component is determined based on bending of the resilient component.

13. The method according to claim 1,
wherein the components of the spring assembly requiring energy are operated by electric current.

14. The method according to claim 11,
wherein the spring assembly comprises a buffer storage for energy,
wherein:
the buffer storage is recharged:
from outside without contact by means of electromagnetic radiation or induction; and/or
by an internal energy generator which is part of the spring assembly.

15. The method according to claim 11,
wherein a load on the resilient component is measured and/or the measured load values are transmitted to an interrogation unit only on interrogation from outside,
at least or only during the interrogation from the interrogation unit to the transmitting unit, energy is transmitted to the latter by electromagnetic radiation.

16. The method according to claim 11,
wherein for internal energy generation, bending or movement or a temperature of the resilient component or the energy generator is converted into energy.

17. The method according to claim 11,
a temperature of the resilient component or of air surrounding the resilient component is measured;
and/or
a content of substances harmful to the resilient component in an environment around the resilient component, is measured;
and/or
acceleration or distance traveled of the resilient component is measured.

18. The method according to claim 11, wherein:
from
the measured loads on the resilient component;
and/or
from pollutant content around the resilient component and exposure time;
and/or
by measuring a strain at a critical and/or most heavily loaded locations of the resilient component, and comparing these values with stresses permitted for the specific material of the resilient component, and calculating therefrom damage to the resilient component both in terms of force and remaining service life,
an evaluation unit, which can be a component of an interrogation unit, calculates a residual force still present and/or an expected remaining service life of the resilient component and informs the operator via an output unit of the monitoring unit.

19. The method according to claim 11,
wherein electrical conductive tracks of the load sensor are also used offset in time to the measurement of the load on the resilient component, as an antenna of a transponder as an RFID antenna and or for current generation.

20. The method according to claim 11,
wherein conductive tracks of a DMS are made of a semiconductor and are also used for current generation due to their piezo effect.
